(19) United States
(12) Patent Application Publication
(10) Pub. No.: US 2011/0320131 A1
(43) Pub. Date: Dec. 29, 2011

(54) BIOLOGICAL INFORMATION PROCESSING APPARATUS, BIOLOGICAL INFORMATION DISPLAY APPARATUS, TELEMEDICAL SYSTEM, TELEMEDICAL METHOD, PROCESSING CONTROL PROGRAM, DISPLAY CONTROL PROGRAM, AND STORAGE MEDIUM

(75) Inventors: Takashi HIBINO, Osaka-shi (JP); Sachiko KUGE, Osaka-shi (JP)

(73) Assignee: SHARP KABUSHIKI KAISHA, Osaka-shi (JP)

(21) Appl. No.: 13/167,756

(22) Filed: Jun. 24, 2011

(30) Foreign Application Priority Data
Jun. 28, 2010 (JP) 2010-146317

(51) Int. Cl. G06F 19/26

(52) U.S. Cl. 702/19

(57) ABSTRACT

In order that a telemedical system which can take into account reliability of data from a patient is provided, a patient-side terminal in the telemedical system is connected with a server via a communications network, and includes a communication section which obtains first biological information indicating a physiological state of a user from a sensing apparatus which measures a physiological state of a user, an input section which accepts an input from a user so as to obtain second biological information, and a control section which (i) adds, to the first biological information, first distinguishing information indicating that the first biological information is information obtained by the communication section, and (ii) adds, to the second biological information, second distinguishing information indicating that the second biological information is information obtained by the input section, so that the first biological information and the second biological information are distinguished from each other. The communication section transmits the distinguishable first and second biological information to the server.

This Nonprovisional application claims priority under 35 U.S.C. §119(a) on Patent Application No. 2010-146317 filed in Japan on Jun. 28, 2010, the entire contents of which are hereby incorporated by reference.

### TECHNICAL FIELD

The present invention relates to a biological information processing apparatus, a biological information display apparatus, and a telemedical system which are suitably utilized in telemedicine between a patient such as a home-care patient and an outpatient and an expert such as a doctor and a registered dietician.

### BACKGROUND ART

A recent major method for providing medical care to home-care patients and outpatients is such a method that a patient regularly visits a medical institution so that an expert such as a doctor determines a condition of the patient on the basis of a measurement result obtained from the patient by use of a medical device and/or a healthcare device in the medical instruction. Such a method has a problem in that outpatients have to spend a long time waiting relative to an actual time for medical care. Further, in a case where a patient visits a plurality of medical institutions due to a single disease, the patient has to take similar tests at the plurality of medical institutions. This leads not only to waste of time but also to a problem of an increased medical cost.

A possible method for remedying these problems is such a method that a patient obtains a measurement result related to a daily health condition of the patient by use of a healthcare device in a home of the patient, in order that the measurement result is utilized in diagnosis. However, according to the method, an expert who diagnoses a patient has to obtain the measurement result directly from the patient. In addition, the expert cannot easily obtain the measurement result. Therefore, usually, such a measurement result is not utilized in diagnosis.

In order that the problems are solved, there proposed systems by which an expert remotely diagnoses a patient on the basis of a measurement result obtained by the patient in his home.

For example, Patent Literature 1 discloses an art for a telemedical system. The telemedical system disclosed in Patent Literature 1 is a system which has a patient-side terminal, a doctor-side terminal, and a telemedical server which communicates with the patient-side terminal and the doctor-side terminal via a network. The telemedical system is suitably used between a patient and a doctor, mainly in telemedicine of chronic diseases. The telemedical system gives, to a patient, such a sense of reassurance that the patient can receive, in his home, health management from a doctor. In addition, the telemedical system makes it easy to carry on the health management.

Patent Literature 2 discloses an art for a health management system. The health management system disclosed in Patent Literature 2 makes it possible to provide, to a patient suffering from a lifestyle-related disease and to a potential patient who wishes to receive healthcare, (i) a network to a medical institution or the like, (ii) support for daily health management which is conducted by the patient himself or by a doctor, and (iii) medical information required for the health management. The health management system finds accurate information on the basis of (i) biological information which is a measurement result that a patient has obtained in his home by use of a vital sensor, (ii) a clerking and a result of a medical checkup which are obtained in a medical institution, and (iii) personal information of the patient. Such accurate information is provided to the patient as feedback. This allows the patient to utilize the information in his health management.

### Citation List

Patent Literature 1

Japanese Patent Application Publication, Tokukai, No. 2003-178142 A (Publication Date: Jun. 27, 2003)

Patent Literature 2

Japanese Patent Application Publication, Tokukai, No. 2002-56099 A (Publication Date: Feb. 20, 2002)

### SUMMARY OF INVENTION

### Technical Problem

However, the conventional arts have the following problems.

The telemedical system disclosed in Patent Literature 1 is not arranged such that patient information to be notified via a network connection from a patient-side terminal to a telemedical server contains that biological information of the patient which is measured by use of a healthcare device in his home. Therefore, an expert such as a doctor cannot diagnose the patient in consideration of reliability of the notified patient information.

According to the health management system disclosed in Patent Literature 2, an expert has a difficulty in grasping what kind of device a patient utilizes to obtain data and whether or not the patient appropriately obtains the data. Therefore, the expert cannot diagnose the patient in consideration of reliability of the patient information.

The present invention was made in view of the problems. An object of the present invention is to provide a telemedical system which makes it possible to take into account reliability of patient data, and an information processing apparatus and an information display apparatus which realize a telemedical system.

### Solution to Problem

In order to attain the object, a biological information processing apparatus of the present invention includes: information obtaining means for obtaining first biological information indicative of a physiological state of a user from a measurement apparatus which measures the first biological information; input accepting means for accepting an input from the user so as to obtain second biological information indicative of a physiological state of the user; processing means for (i) adding, to the first biological information, first distinguishing information indicating that the first biological information is information obtained by the information obtaining means, and (ii) adding, to the second biological information, second distinguishing information indicating that the second biological information is information obtained by the input accepting means, so that the first biological information and the second biological information are distinguished from each other; and transmitting means for transmitting, to the server, at least any one of the first biological information having the first distinguishing information and the second biological information having the second distinguishing information, the biological information processing apparatus being connected with the server via a communication network.

According to the arrangement, the biological information processing apparatus can directly obtain, from the measurement device, first biological information indicative of a physiological state. Also, the biological information processing apparatus can obtain second biological information by accepting an input from a user. The biological information processing apparatus can (i) add, to the first biological information, first distinguishing information indicating that the first biological information is information directly obtained by the measurement device, (ii) add, to the second biological information, second distinguishing information indicating that the second biological information is information obtained by accepting an input from a user, so that the first biological information and the second biological information are distinguished from each other, and transmit the first and second biological information to the server.

Therefore, in a case where another user utilizes the first and second biological information received by the server, the user can distinguish whether each of the first biological information and the second biological information is information directly obtained by the measurement apparatus or information inputted by a user. This allows an expert such as a doctor to determine a body condition of a patient on the basis of the first and second biological information of the patient, in consideration of reliability of the first and second biological information. As a result, the expert can determine the body condition more accurately.

A biological information processing apparatus of the present invention includes: any one of information obtaining means and input accepting means, the information obtaining means for obtaining first biological information indicative of a physiological state of a user from a measurement apparatus which measures the first biological information, the input accepting means for accepting an input from the user so as to obtain second biological information indicative of a physiological state of the user; and processing means for (i) adding, to the first biological information, first distinguishing information indicating that the first biological information is information obtained by the information obtaining means, or (ii) adding, to the second biological information, second distinguishing information indicating that the second biological information is information obtained by the input accepting means, so that the first biological information and the second biological information are distinguished from each other; and transmitting means for transmitting, to the server, the first biological information having the first distinguishing information or the second biological information having the second distinguishing information, the biological information processing apparatus being connected with the server via a communication network.

According to the arrangement, the biological information processing apparatus can (i) add, to the first biological information, first distinguishing information indicating that the first biological information is information directly obtained by the measurement apparatus, and (ii) add, to the second biological information, second distinguishing information indicating that the second biological information is information obtained by accepting an input from a user, so that the first biological information and the second biological information are distinguished from each other, and transmit the first and second biological information to the server.

Therefore, in a case where another user utilizes the first and second biological information received by the server, the user can distinguish whether each of the first biological information and the second biological information is information directly obtained by the measurement apparatus or information inputted by a user. This allows an expert such as a doctor to determine a body condition of a patient on the basis of the first and second biological information of the patient, in consideration of reliability of the first and second biological information. As a result, the expert can determine the body condition more accurately.

In order to attain the object, a biological information display apparatus of the present invention includes: receiving means for receiving, from a biological information processing apparatus, at least any one of first biological information and second biological information each of which indicates a physiological state of a user, the first biological information and the second biological information each obtained by the biological information processing apparatus; determining means for determining whether the at least any one of the first biological information and the second biological information which at least any one of the first biological information and the second biological information was received by the receiving means is information obtained by a measurement apparatus which measures first biological information or information inputted by the user; and display means for causing, on the basis of a determination thus made by the determining means, the at least any one of the first biological information and the second biological information to be displayed on a display screen so that whether the at least any one of the first biological information and the second biological information is information obtained by the measurement apparatus or information inputted by the user can be distinguished.

According to the arrangement, the biological information display apparatus receives, from a biological information processing apparatus, the first and second biological information obtained by the biological information processing apparatus, and displays the received first and second biological information on the display screen. In this process, the biological information processing apparatus determines whether each of the first biological information and the second biological information is information obtained by the measurement apparatus which measures first biological information or information inputted by a user, and displays, on the basis of the determination thus made, the first biological information and the second biological information so that whether each of the first biological information and the second biological information is information obtained by the measurement apparatus or information inputted by the user can be distinguished.

Therefore, this allows an expert such as a doctor to determine a body condition of a patient on the basis of the first and second biological information of the patient, in consideration of reliability of the first and second biological information. As a result, the expert can determine the body condition more accurately.

The present invention encompasses a telemedical system including the biological information processing apparatus and the biological information display apparatus.

That is, a telemedical system of the present invention includes: a measurement apparatus which measures first biological information indicative of a physiological state of a user; a biological information processing apparatus; a biological information display apparatus; and a server which communicates, via a network, with the biological information processing apparatus and with the biological information display apparatus, the biological information processing apparatus including: information obtaining means for obtaining first biological information indicative of a physiological state of a user from the measurement apparatus; input accepting means for accepting an input from the user so as to obtain second biological information indicative of a physiological state of the user; processing means for (i) adding, to the first biological information, first distinguishing information indicating that the first biological information is information obtained by the information obtaining means, and (ii) adding, to the second biological information, second distinguishing information indicating that the second biological information is information obtained by the input accepting means, so that the first biological information and the second biological information are distinguished from each other; and transmitting means for transmitting, to the server, at least any one of the first biological information having the first distinguishing information and the second biological information having the second distinguishing information, the biological information display apparatus including: receiving means for receiving at least any one of the first biological information and the second biological information from the server; determining means for determining whether the at least any one of the first biological information and the second biological information is information obtained by the measurement apparatus or information obtained in such a manner that the biological information processing apparatus accepts an input from the user; and display means for causing, on the basis of a determination thus made by the determining means, the at least any one of the first biological information and the second biological information to be displayed on a display screen so that whether the at least any one of the first biological information and the second biological information is information obtained by the measurement apparatus or information inputted by the user can be distinguished.

In order to attain the object, a telemedical method of the present invention includes: an information obtaining step in which a biological information processing apparatus which obtains first biological information and second biological information each of which indicates a physiological state of a user obtains first biological information from a measurement apparatus which measures first biological information; an input accepting step in which the biological information processing apparatus accepts an input from the user so as to obtain second biological information; a processing step in which the biological information processing apparatus (i) adds, to the first biological information obtained in the information obtaining step, first distinguishing information indicating that the first biological information is information obtained in the information obtaining step, and (ii) adds, to the second biological information obtained in the input accepting step, second distinguishing information indicating that the second biological information is information obtained in the input accepting step, so that the first biological information and the second biological information are distinguished from each other; a transmitting step in which the biological information processing apparatus transmits, to a server, the first biological information having the first distinguishing information and the second biological information having the second distinguishing information; a receiving step in which a biological information display apparatus which displays first biological information and second biological information receives the first biological information and the second biological information from the server; a determining step in which the biological information display apparatus determines whether each of the first biological information and the second biological information is information that the biological information processing apparatus obtained from the measurement apparatus or information obtained in such a manner that the biological information processing apparatus accepted the input form the user; and a displaying step in which the biological information display apparatus causes, on the basis of a determination thus made in the determining step, the first biological information and the second biological information to be displayed on a display screen so that whether each of the first biological information and the second biological information is information obtained by the measurement apparatus or information inputted by the user can be distinguished.

Each of the biological information processing apparatus and the biological information display apparatus can be realized by a computer. In this case, the scope of the present invention encompasses (i) a processing control program and a display control program that realize the biological information processing apparatus and the biological information display apparatus on a computer by causing the computer to operate as respective means and (ii) a computer-readable storage medium storing the processing control program and the display control program.

### ADVANTAGEOUS EFFECTS OF INVENTION

As described above, the biological information processing apparatus of the present invention (i) adds, to the first biological information, first distinguishing information indicating that the first biological information is information directly obtained by the measurement apparatus, and (ii) adds, to the second biological information, second distinguishing information indicating that the second biological information is information obtained by accepting an input from a user, so that the first biological information and the second biological information are distinguished from each other.

The biological information display apparatus of the present invention displays the first and second biological information so that whether each of the first biological information and the second biological information is information directly obtained from the measurement apparatus or information obtained by accepting an input from a user can be distinguished.

This allows an expert who determines a physiological state of a patient on the basis of the first and second biological information to diagnose and treat the patient in consideration of reliability of the first and second biological information.

### BRIEF DESCRIPTION OF DRAWINGS

FIG. 1

FIG. 1 is a block diagram illustrating respective arrangements of devices and terminals included in a telemedical system of the present embodiment.

FIG. 2

FIG. 2 is a schematic view illustrating an arrangement of the telemedical system of the present embodiment.

FIG. 3

FIG. 3 is a view illustrating one example of a display screen image displayed on an expert-side display apparatus of the present embodiment.

FIG. 4

FIG. 4 is a sequence diagram illustrating a flow of an initial setting process of the telemedical system of the present embodiment.

FIG. 5

FIG. 5 is a sequence diagram illustrating a flow of a process of obtaining and storing first and second biological information.

FIG. 6

FIG. 6 is a sequence diagram illustrating a flow of a process of displaying a medical care result on the patient-side terminal of the telemedical system of the present embodiment.

FIG. 7

FIG. 7 is a sequence diagram illustrating a flow of a process of displaying biological information on the expert-side display apparatus of the telemedical system of the present embodiment.

FIG. 8

FIG. 8 is a sequence diagram illustrating a flow of a process of storing and notifying a medical care result in the telemedical system of the present embodiment.

### DESCRIPTION OF EMBODIMENTS

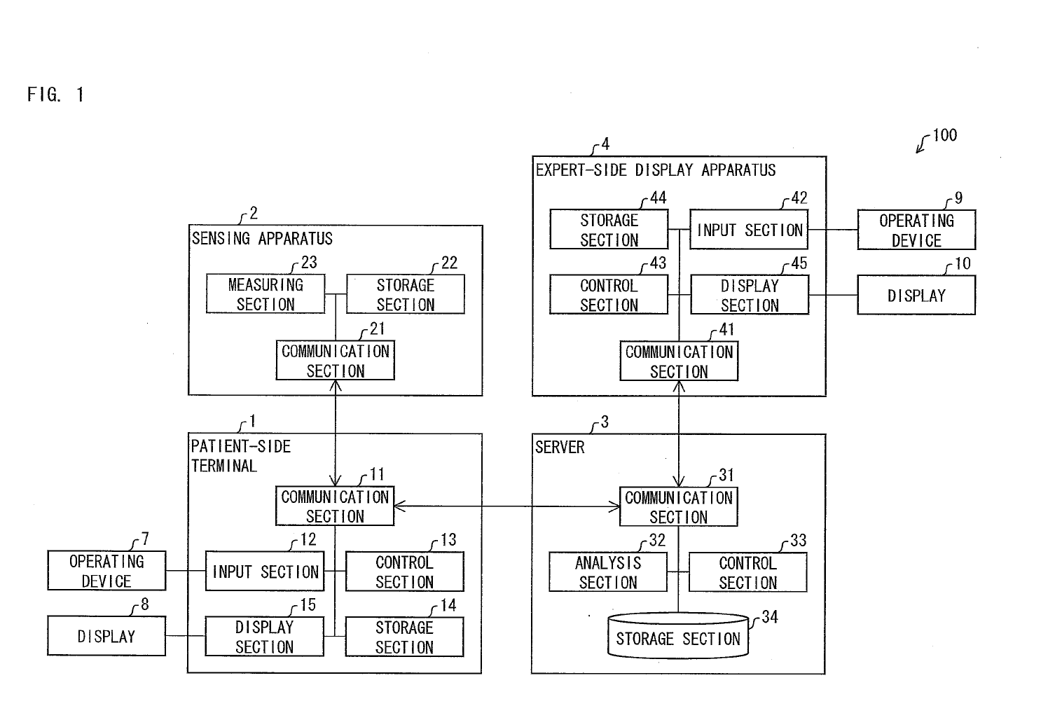

The following describes one embodiment of a telemedical system of the present invention, with reference to FIGS. 1 to 8.

(Arrangement of Telemedical System)

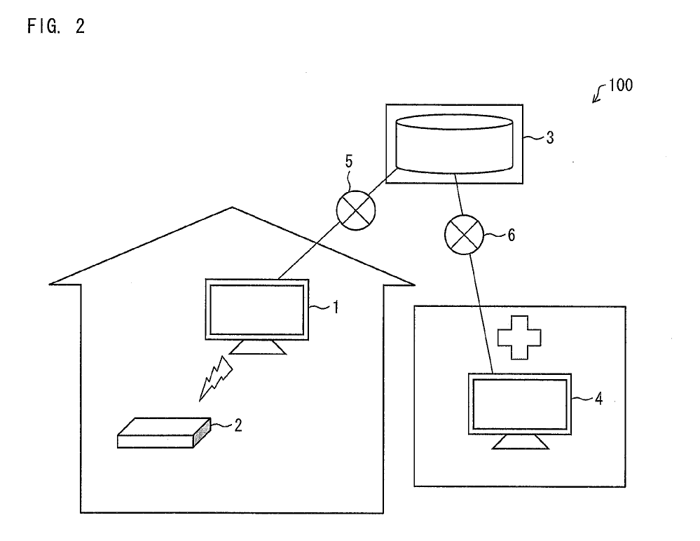

The following first describes the telemedical system of the present embodiment, with reference to FIG. 2.

FIG. 2 is a schematic view illustrating an arrangement of the telemedical system of the present embodiment. As illustrated in FIG. 2, a telemedical system 100 includes a patient-side terminal (biological information processing apparatus) 1, a sensing apparatus (measurement apparatus) 2, a server 3, and an expert-side display apparatus (biological information display apparatus) 4.

The patient-side terminal 1 and the sensing apparatus 2 are arranged so that at least the sensing apparatus 2 transmits various kinds of data to the patient-side terminal 1 via wired or wireless communication. Examples of a method for communication between the patient-side terminal 1 and the sensing apparatus 2 encompass wireless data communication such as Bluetooth®, infrared communication, and wireless LAN, and wired connection via a cable, a USB interface, or the like. A communication function of the patient-side terminal 1 is not necessarily provided in the patient-side terminal 1. Instead, the communication function can be provided in an apparatus having no display function such as in a set-top box and in a home gateway. Although FIG. 2 illustrates one sensing apparatus 2, it can be arranged such that a plurality of sensing apparatuses 2 transmit and receive data to/from the patient-side terminal 1.

The patient-side terminal 1 and the server 3 are connected with each other via a network 5 such as the Internet so as to exchange data via the network 5. Although FIG. 2 shows that one patient-side terminal 1 is connected with the server 3 via the network 5, it can be arranged such that a plurality of patient-side terminals 1 are connected with the server 3 via the network 5.

The expert-side display apparatus 4 and the server 3 are connected with each other via a network 6 such as the Internet so as to exchange data via the network 6.

Then, the following describes sections included in the telemedical system 100, with reference to FIG. 1. FIG. 1 is a block diagram illustrating respective arrangements of the patient-side terminal 1, the sensing apparatus 2, the server 3, and the expert-side display apparatus 4.

(Patient-Side Terminal)

The following first describes the patient-side terminal 1. As illustrated in FIG. 1, the patient-side terminal 1 includes a communication section (information obtaining means, transmitting means) 11, an input section (input accepting section) 12, a control section (processing means) 13, a storage section 14, and a display section 15. The patient-side terminal 1 is connected with an operating device 7 and with a display 8 such as an LCD (Liquid Crystal Display). The operating device 7 and the display 8 can be integrated with the patient-side terminal 1. The patient-side terminal 1 can be, e.g., a television apparatus.

The communication section 11 transmits and receives data to/from the sensing apparatus 2 via wired or wireless communication so as to obtain, from the sensing apparatus 2, data such as first biological information of a patient which first biological information is a measurement result obtained by the sensing apparatus 2, and apparatus information of the sensing apparatus 2 (measurement apparatus information). The communication section 11 also transmits and receives various kinds of data to/from the server 3 via the network 5.

The input section 12 accepts data such as second biological information and user information of a patient which have been directly inputted by the patient himself by use of the operating device 7.

The control section 13 causes the storage section 14 to store various kinds of data such as the first biological information obtained from the communication section 11 and the second biological information obtained from the input section 12. The control section 13 causes the storage section 14 to store the first and second biological information so that the first biological information obtained from the communication section 11 and the second biological information obtained from the input section 12 are distinguishable from each other. The control section 13 also extracts data from the storage section 14 so as to cause, via the display section 15, the display 8 to display the data on its display screen.

The display section 15 causes the display 8 to display the first and second biological information, the apparatus information, etc. as image information, character information, or a combination thereof, in order to present content of various kinds of data to a patient. According to the present embodiment, the display section 15 causes the display 8 to electronically display such data. However, alternatively, the content of various kinds of data can be printed so as to be presented to a patient. Further, the content can be presented to a patient as handwritten information.

The storage section 14 is a storage device which stores various kinds of data. The storage device can be, e.g., a hard disk, a flash memory, a RAM, or the like. The storage section 14 has a user information storage area, an apparatus information storage area, and a biological information storage area, in accordance with types of information that the storage section 14 stores.

According to the present embodiment, the communication section 11 receives the first biological information from the sensing apparatus 2, and the input section 12 accepts the second biological information from a user. However, it can be arranged such that the communication section 11 receives first biological information or the input section 12 accepts second biological information. Even in this case, the control section 13 causes the storage section 14 to store the first and second biological information so that the first biological information obtained from the communication section 11 and the second biological information obtained from the input section 12 are distinguishable from each other.

(Sensing Apparatus)

The following describes the sensing apparatus 2. As illustrated in FIG. 1, the sensing apparatus 2 includes a communication section 21, a storage section 22, and a measuring section 23.

The measuring section 23 includes at least one sensor which obtains first biological information of a patient. The sensor can be (i) a pulse sensor, a blood pressure sensor, a body temperature sensor, or the like which obtains a quantitative measurement result, (ii) an activity level sensor, a fatigue level sensor, or the like which obtains a nonquantitative measurement result, or (iii) another conventional sensor. Each of the activity level sensor and the fatigue level sensor can be an acceleration sensor.

In a case where a sensor, such as the activity level sensor and the fatigue level sensor, which obtains a nonquantitative measurement result is employed, a measurement result obtained by the sensor is converted into a quantitative index so as to be then transmitted as data. As for an activity level which cannot be easily evaluated quantitatively, for example, an acceleration measured by an acceleration sensor is converted into a quantitatively-evaluable index called “METS (metabolic equivalents) value” which indicates an exercise intensity. This allows an expert such as a doctor to utilize an activity level converted into a METS value in determination of a condition of a patient.

The measuring section 23 can includes not only the sensor which obtains first biological information of a patient but also a sensor which measures environmental conditions of a room such as a temperature (room temperature), a humidity, a dust level, etc.

The communication section 21 transmits and receives various kinds of data to/from the patient-side terminal 1 via wired or wireless communication.

The storage section 22 is a storage device which stores the various kinds of data. As is the case with the storage section 14 of the patient-side terminal 1, the storage section 22 can be a hard disk, a flash memory, a RAM, or the like.

(Server)

The following describes the server 3. As illustrated in FIG. 1, the server 3 includes a communication section 31, an analysis section 32, a control section 33, and a storage section 34.

The communication section 31 transmits and receives various kinds of data to/from the patient-side terminal 1 and the expert-side display apparatus 4 via the networks 5 and 6.

The storage section 34 is a database storing the various kinds of data obtained from the communication section 31. The storage section 34 is divided into the following three areas, a user information area, an apparatus information area, and a biological information area so that the user information, the apparatus information, and the biological information are stored and managed in the three areas, respectively.

The analysis section 32 generates information to be presented to a patient and information to be presented to an expert, on the basis of data obtained from the patient-side terminal 1 such as the user information, the apparatus information, the first and second biological information, etc., and data obtained from the expert-side display apparatus 4 such as medical information on an electronic medical record or the like.

The control section 33 causes the storage section 34 to store the various kinds of data obtained from the communication section 31. The control section 33 also causes the communication section 31 to transmit the information generated by the analysis section 32 to the patient-side terminal 1 and/or the expert-side display apparatus 4, in accordance with a data request(s) from the patient-side terminal 1 and/or the expert-side display apparatus 4.

(Expert-side Display Apparatus 4)

The following describes the expert-side display apparatus 4. As illustrated in FIG. 1, the expert-side display apparatus 4 includes a communication section (receiving means) 41, an input section 42, a control section (determining means) 43, a storage section 44, and a display section (display means) 45. The expert-side display apparatus 4 is connected with an operating device 9 such as a keyboard, and with a display 10 such as an LCD. The operating device 9 and the display 10 can be integrated with the expert-side display apparatus 4. The expert-side display apparatus 4 can be, e.g., a personal computer.

The communication section 41 transmits and receives various kinds of data to/from the server 3 via the network 6.

The input section 42 accepts data such as patient subjective information, expert objective information, a diagnosis result, a treatment plan, etc. which have been inputted by an expert by use of the operating device 9.

The control section 43 causes the storage section 44 to store various kinds of data obtained from the communication section 41 and the input section 42. The control section 43 also extracts data from the storage section 44 so as to cause, via the display section 45, the display 10 to display the data on its display screen.

The display section 45 causes the display 10 to display data on its display screen as image information, character information, or a combination thereof, in order to present content of the data to an expert. According to the present embodiment, the display section 45 causes the display 10 to electronically display such data. However, alternatively, the content of the data can be printed so as to be presented to an expert. Further, the content can be presented to an expert as handwritten information.

The storage section 44 is a storage device which stores various kinds of data. The storage device can be, e.g., a hard disk, a flash memory, a RAM, or the like. The storage section 44 has a user information storage area, an apparatus information storage area, and a biological information storage area, in accordance with types of information that the storage section 44 stores.

(Overview of Telemedical System)

The following describes an overview of the telemedical system 100.

In the telemedical system 100, the patient-side terminal 1 displays information processed for a patient, and the expert-side display apparatus 4 displays information processed for an expert.

The server 3 stores (i) the first biological information of a patient, the environmental information, and the apparatus information which have been transmitted from the sensing apparatus 2 to the patient-side terminal 1, (ii) the second biological information and the user information which have been inputted by the patient himself into the patient-side terminal 1, and (iii) electronic medical record information such as third biological information and a diagnosis result of the patient which have been inputted by an expert into the expert-side display apparatus 4. The server 3 stores such information so as to correlate the pieces of information by a user ID.

In a case where the expert-side display apparatus 4 requests the server 3 to transmit data to the expert-side display apparatus 4, the server 3 extracts requested data from the database and transmits the requested data to the expert-side display apparatus 4. In a case where the server 3 transmits a piece of first, second, or third biological information to the expert-side display apparatus 4, the server 3 transmits the piece of first, second, or third biological information together with a parameter which indicates whether the piece of first, second, or third biological information is first biological information that the patient-side terminal 1 has automatically obtained from the sensing apparatus 2, second biological information which has been inputted by a patent himself into the patient-side terminal 1, or third biological information which has been inputted by an expert into the expert-side display apparatus 4. A parameter which indicates whether a piece of first or second biological information is first biological information or second biological information is added to a piece of first or second biological information, on the patient-side terminal 1. In accordance with the parameter, the expert-side display apparatus 4 changes how to display the piece of first, second, or third biological information thus received from the server 3.

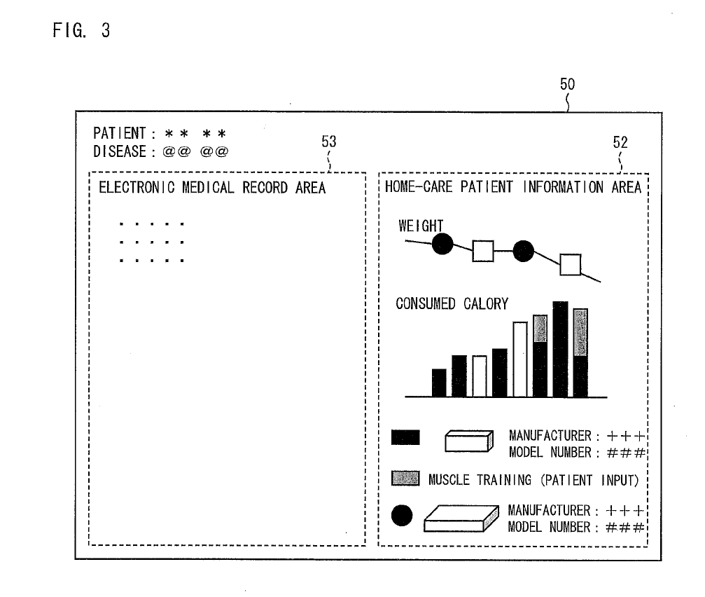

In a case where, e.g., the measuring section 23 of the sensing apparatus 2 is a weight scale, i.e., the first biological information is data indicative of a body weight of a patient, and the body weight is taken regularly, the first biological information can be displayed in the form of a line graph or the like. In this case, a mark plotting a line in the line graph is varied from one method for obtaining body weight data to another so that how the body weight data was obtained is presented to an expert in an understandable way. FIG. 3 is a view illustrating one example of a display screen image displayed on the display 10 of the expert-side display apparatus 4. In a display screen image 50 of FIG. 3, a plurality of pieces of information such as a patient name and a disease name, and also electronic medical record information, the first and second biological information of the patient, the apparatus information of the sensing apparatus 2, etc. are displayed in combination. The display screen image 50 is divided into an electronic medical record area 53 where electronic medical record information is displayed and a home-care patient information area 52 where first and second biological information of a patient and apparatus information are displayed. In the display screen image 50, body weight data is displayed in the form of a line graph in the home-care patient information area 52. In the display screen image 50, black circles indicate more reliable data that the patient-side terminal 1 automatically obtained from the sensing apparatus 2 whereas white squares indicate body weight data that a patient inputted into the patient-side terminal 1.

In a case where the measuring section 23 of the sensing apparatus 2 is a pedometer, and the first biological information indicates an amount of consumed calories, the first biological information can be displayed in the form of a bar graph or the like. In this case, a color of a bar in the bar graph is varied from one method for obtaining consumed calory data to another so that how the consumed calory data was obtained is presented to an expert in an understandable way. In the home-care patient information area 52 of the display screen image 50, the body weight data and also the consumed calory data are displayed as biological information, which consumed calory data is displayed in the form of a bar graph. In the display screen image 50, black bars indicate consumed calories on the basis of more reliable data that the patient-side terminal 1 automatically obtained from the sensing apparatus 2 whereas white bars indicate consumed calories on the basis of that data indicative of the number of steps which was inputted by a patient into the patient-side terminal 1. In the display screen image 50, the consumed calories based on the number of steps and also that consumed calories based on another exercise data inputted by a patient himself are displayed which are indicated by gray bars.

Other pieces of information displayed in the display screen image 50 are (i) the apparatus information indicative of what healthcare device (model number) of what manufacturer has been employed as the sensing apparatus 2 used in measurement of the first biological information and (ii) information indicative of what kind of exercise data has been inputted by a patient.

This allows an expert to know how the first and second biological information of a patient was obtained. This allows the expert to diagnose a patient in view of data reliability.

Therefore, the use of the telemedical system 100 makes it possible to provide information on a patient to an expert most appropriately. As a result, accuracy of telemedical diagnosis can be increased.

(Processing by Telemedical System)

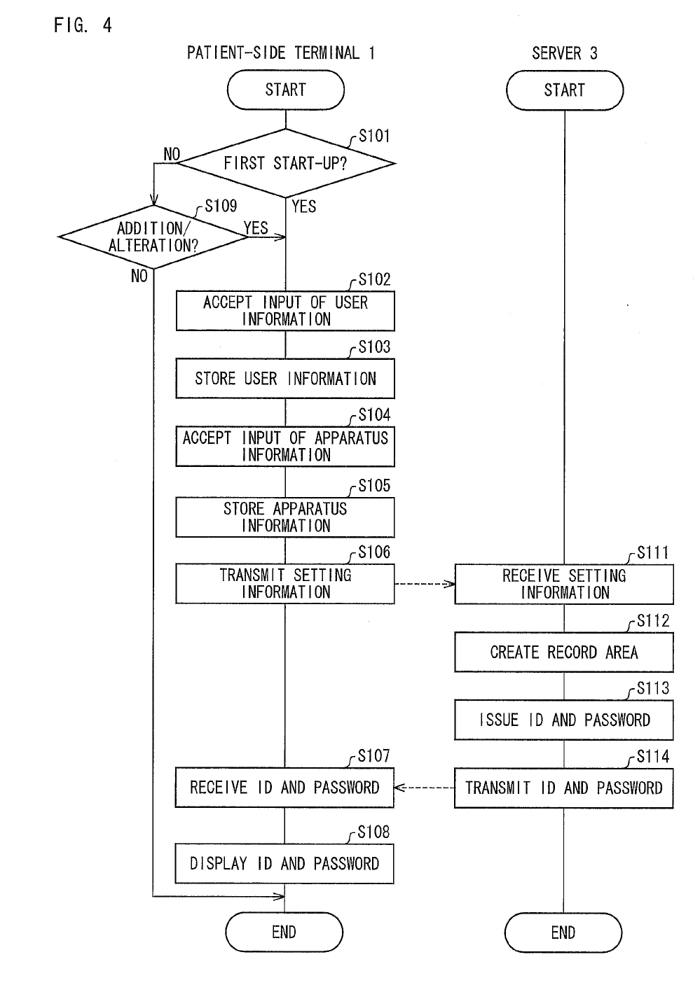

The following describes one example of processing to be carried out by the telemedical system 100, with reference to FIGS. 4 to 8.

<Initial Setting Process>

The following first deals with an initial setting process of the telemedical system 100, with reference to FIG. 4. In the initial setting process, a user (patient) registers the apparatus information of the sensing apparatus 2, personal information of the user, etc. in the server 3. FIG. 4 is a sequence diagram showing a flow of the initial setting process of the telemedical system 100.

First, the user starts up a telemedical application on the patient-side terminal 1. After the telemedical application is started up, steps shown in FIG. 4 are carried out. The telemedical application can be obtained by any way.

With reference to FIG. 4, the following describes steps to be carried out after the telemedical application is started up, (i) steps S101 to S109 which indicate steps to be carried out on the patient-side terminal 1 and (ii) steps S111 to S114 which indicate steps to be carried out on the server 3.

After the telemedical application is started up, the control section 13 of the patient-side terminal 1 determines whether or not this start-up of the telemedical application is a first one (S101).

If Yes, the input section 12 of the patient-side terminal 1 accepts user information which has been inputted by the user by use of the operating device 7 (S102). In S102, instead, In S102, instead, the patient-side terminal 1 can accept user information stored in an external device. Examples of the user information encompass personal data such as sex, a birth date, and a body height, and application-dependent data such as a diet target value. After the input section 12 accepts the user information, the control section 13 causes the storage section 14 to store the user information in the user information storage area of the storage section 14 (S103).

Then, the input section 12 accepts apparatus information which has been inputted by the user by use of the operating device 7 (S104). Examples of the apparatus information encompass a name of a manufacturer of the sensing apparatus 2, a product name of the sensing apparatus 2, and a location of the sensing apparatus 2. In S104, instead, the patient-side terminal 1 can automatically obtain the apparatus information from the sensing apparatus 2 via the communication section 11 and a network connection. After the input section 12 accepts the apparatus information directly or the communication section 11 obtains the apparatus information, the control section 13 causes the storage section 14 to store the apparatus information in the apparatus information storage area of the storage section 14 (S105). An order in which the user information and the apparatus information are obtained is not limited to this. The user information can be obtained after the apparatus information is obtained.

Then, the communication section 11 transmits, to the server 3, setting information such as the user information and the apparatus information which have been stored in the storage section 14 (S106). In a case where the communication section 11 cannot confirm transmission completion on the basis of receipt of ACK/NACK, the communication section 11 retransmits the setting information to the server 3.

In a case where, e.g., the user information is altered or new apparatus information of the sensing apparatus 2 is added, the input section 12 and/or the communication section 11 of the patient-side terminal 1 can accept and/or receive the user information and the apparatus information, provided that the telemedical application is in execution, even if the control section 13 of the patient-side terminal 1 determines that the start-up of the telemedical application is not the first one (Yes in S109).

The communication section 31 of the server 3 receives that setting information such as the user information and the apparatus information which has been transmitted from the patient-side terminal 1 (S111). In response to receipt of the setting information, the control section 33 of the server 3 creates a user record area in the storage section 34, and stores, in the user record area, the user information and the apparatus information that have been received by the communication section 31, thereby creating a database (S112).

Then, the control section 33 generates (issues) an ID of the user and a password corresponding to the ID so as to distinguish the user information of the user from others (S113). Information indicative of the ID and the password are correlated with the user information etc. so as to be stored in the storage section 34. The control section 33 outputs the information indicative of the ID and the password to the communication section 31. The communication section 31 transmits the information indicative of the ID and the password to the patient-side terminal 1 (S114).

After transmitting the user information etc. to the server 3, the communication section 11 of the patient-side terminal 1 receives, from the server 3, the information indicative of the ID and the password which have been generated by the server 3 (S107). The information indicative of the ID and the password is outputted to the display section 15. Then, the display section 15 generates display data so as to cause the display 8 to display the ID and the password on the basis of the display data, and causes the display 8 to display the ID and the password to the user (S108). Thus, the initial setting process is completed. In some cases, the ID and the password are not presented to a user, but are stored in the storage section 14. How the ID and the password are used in such cases is described later.

After the initial setting process is completed, the user can use a telemedical service provided through the telemedical system 100.

In a case where the start-up of the telemedical application by the user is not the first one, and there is no addition nor alteration to each of the user information and the apparatus information, the patient-side terminal 1 ends the initial setting process (No in S109).

<Process of Obtaining Biological Information and Storing the Same in Server>

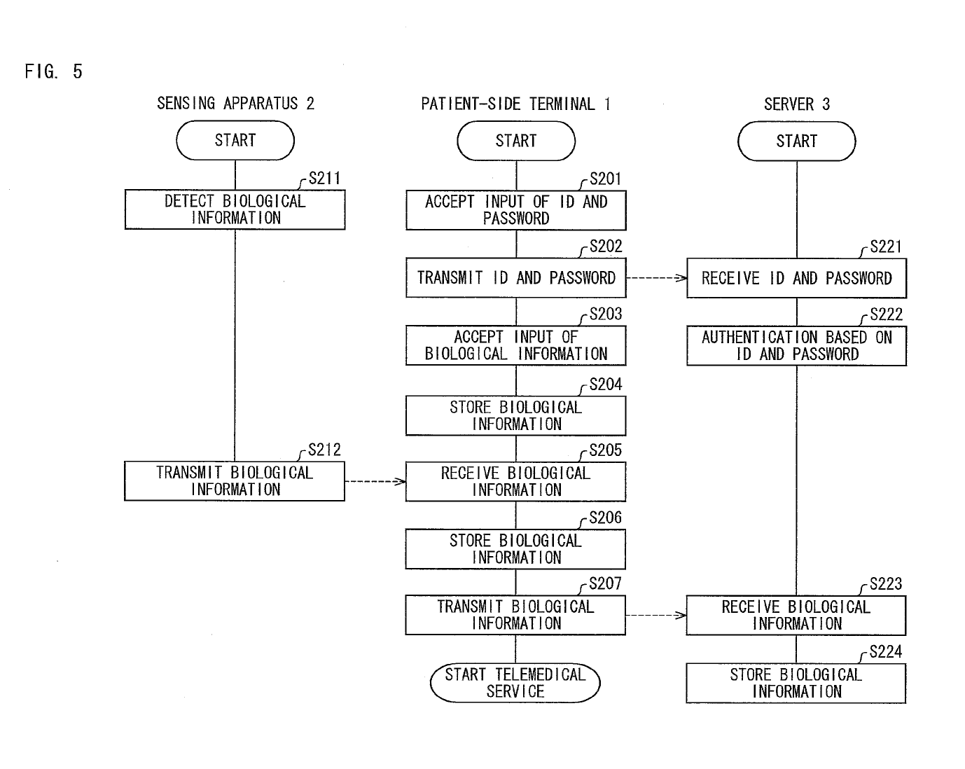

With reference to FIG. 5, the following describes a process of obtaining first and second biological information and storing the first and second biological information in the server 3 which process is carried out on the patient-side terminal 1. FIG. 5 is a sequence diagram illustrating a flow of a process to be carried out before telemedicine is conducted through the telemedical system 100.

The user first stars up the telemedical application on the patient-side terminal 1. In a case where the process follows the initial setting process, there is no need to start up the telemedical application again.

With reference to FIG. 5, the following describes steps to be carried out after the telemedical application is started up, (i) steps S201 to S207 which indicate steps to be carried out on the patient-side terminal 1, (ii) steps S211 and S212 which indicate steps to be carried out on the sensing apparatus 2, and (iii) steps S221 to S224 which indicate steps to be carried out on the server 3.

The input section 12 of the patient-side terminal 1 accepts authentication information made up of an ID and a password which have been inputted by a user by use of the operating device 7 (S201). The input section 12 outputs the authentication information thus received to the communication section 11. The communication section 11 transmits the authentication information to the server 3 (S202). In a case where the telemedical system 100 is a system in which no ID nor password is provided by a user, the telemedical system 100 is arranged such that after the telemedical application is started up, the control section 13 automatically extracts an ID and a password which are stored in the storage section 14 so that the communication section 11 transmits the ID and the password to the server 3. After S202 is carried out, it is possible to alter the setting information and/or register a new sensing apparatus 2, although this is not illustrated in FIG. 5.

After the communication section 11 transmits the authentication information to the server 3, the input section 12 of the patient-side terminal 1 accepts second biological information which has been inputted by a user by use of the operating device 7 (S203). Then, the control section 13 causes the storage section 14 of the patient-side terminal 1 to store, in the biological information storage area in the storage section 14, the second biological information accepted by the input section 12 (S204). In this process, the control section 13 adds, to the second biological information, a parameter which indicates that the second biological information is information accepted by the input section 12, stores, in the biological information storage area, the second biological information having the parameter.

Further, the patient-side terminal 1 obtains first biological information from the sensing apparatus 2.

First, the measuring section 23 of the sensing apparatus 2 measures first biological information such as a heart rate and a blood pressure of a patient (S211). The measuring section 23 outputs the first biological information to the communication section 21 of the sensing apparatus 2. The communication section 21 transmits the first biological information to the patient-side terminal 1 (S212). The sensing apparatus 2 can be arranged to transmit first biological information to the patient-side terminal 1 every time the sensing apparatus 2 obtains the first biological information. Alternatively, the sensing apparatus 2 can be arranged to accumulate first biological information in the storage section 22 of the sensing apparatus 2 so as to transmit accumulated first biological information to the patient-side terminal 1 in a case where the accumulated first biological information reached to a certain amount.

Then, the communication section 11 of the patient-side terminal 11 receives the first biological information from the sensing apparatus 2 (S205). Then, the control section 13 of the patient-side terminal 1 causes the storage section 14 of the patient-side terminal 1 to store, in the biological information storage area in the storage section 14, the first biological information received by the communication section 11 (S206). In this process, the control section 13 adds, to the first biological information, a parameter which indicates that the first biological information is information received by the communication section 11, and stores, in the biological information storage area, the first biological information having the parameter.

According to the arrangement above, the patient-side terminal 1 first obtains the second biological information via the input section 12, and then obtains the first biological information via the communication section 11. However, the present embodiment is not limited to this. Alternatively, it can be arranged such that the patient-side terminal 1 first obtains the first biological information from the sensing apparatus 2 via the communication section 11, and then obtains the second biological information from a user via the input section 12. Alternatively, it can be arranged such that the input section 12 accepts the second biological information from a user, and the communication section 11 simultaneously receives the first biological information from the sensing apparatus 2. Alternatively, it can be arranged such that the patient-side terminal 1 carries out only any one of obtainment of the second biological information via the input section 12 and obtainment of the first biological information via the communication section 11.

The communication section 11 of the patient-side terminal 1 transmits, to the sever 3, the first biological information and/or the second biological information which are stored in the biological information storage area in the storage section 14 (S207). The first biological information and the second biological information have respective aforementioned parameters.

The communication section 31 of the server 3 receives the authentication information made up of the ID and the password from the patient-side terminal 1 (S221). Then, the analysis section 32 refers to the ID and the password which are stored in the storage section 34 so as to authenticate the user based on the authentication information thus received (S222). Then, the communication section 31 receives the first and/or second biological information from the patient-side terminal 1 (S223). Then, the control section 33 causes the storage section 34 to store, in its database corresponding to the ID of the user thus authenticated, the first and/or second biological information thus received (S224).

Thus, the first and second biological information is stored in the server 3.

According to the present embodiment, the patient-side terminal 1 accepts inputs of an ID and a password, and transmits the information indicative of the ID and the password to the server 3 at data transmission to the server 3 so that the server 3 authenticates a user based on the ID and the password. However, this authentication process can be omitted as necessary. The authentication process can be carried out on the server 3 when the patient-side terminal 1 transmits, to the server 3, a data request (to be described later) for a medical care result. The authentication process can also be omitted.

<Process of Outputting Biological Information Stored in Server to Expert-Side Display Apparatus>

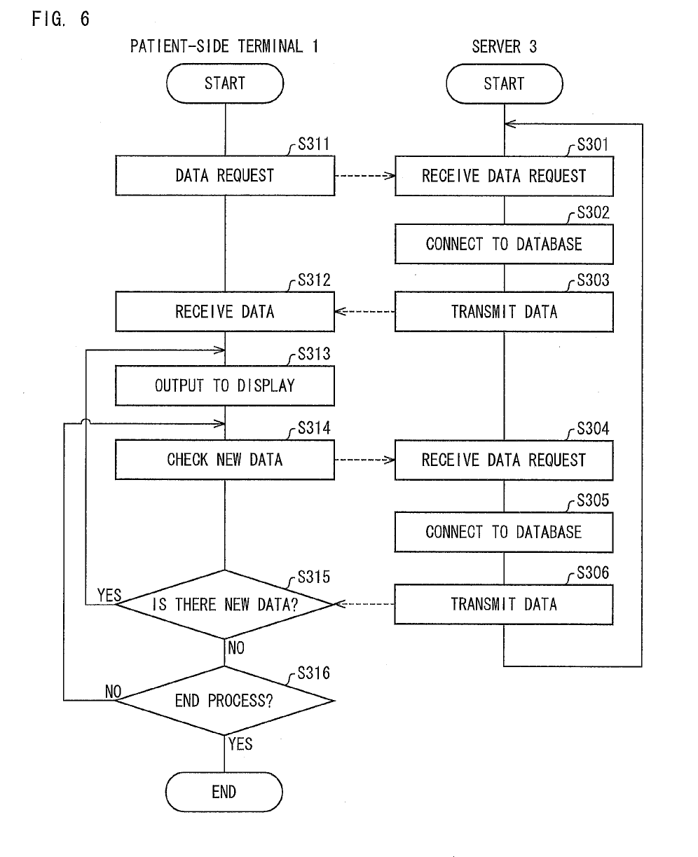

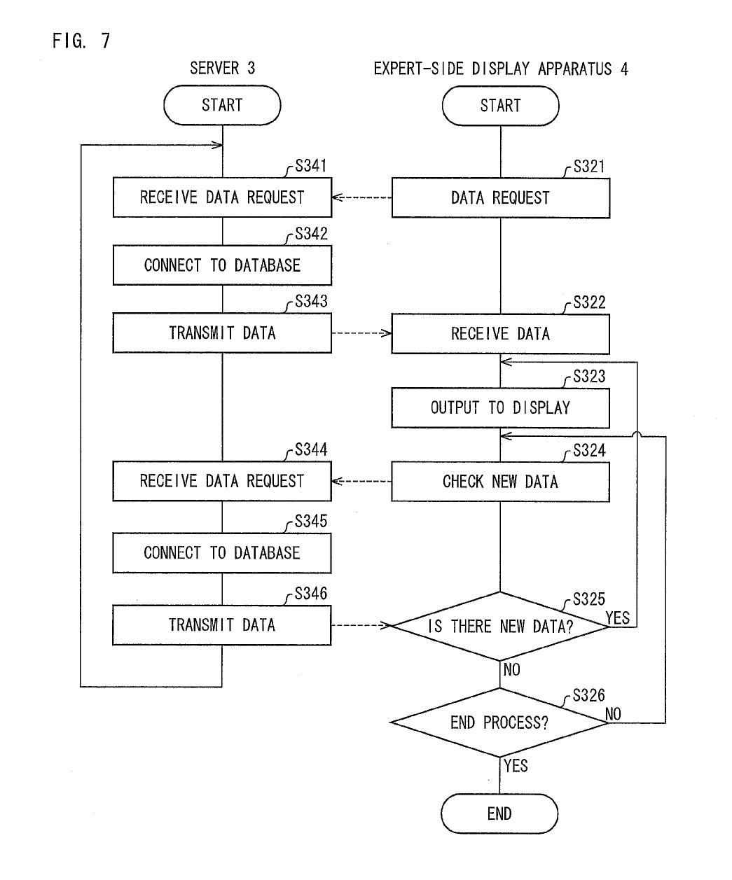

With reference to FIGS. 6 and 7, the following describes a process which is carried out by use of the telemedical system 100 when an expert diagnoses a patient. FIG. 6 is a sequence diagram illustrating respective processing flows of the patient-side terminal 1 and the server 3. FIG. 7 is a sequence diagram illustrating respective processing flows of the expert-side display apparatus 4 and the server 3.

With reference to FIG. 6, the following first deals with a process to be carried out on the patient-side terminal 1 and a process to be carried out between the patient-side terminal 1 and the server 3. First, a patient starts up the telemedical application on the patient-side terminal 1. There is no need to start up the telemedical application again in a case where the process follows the aforementioned obtainment of the first and second biological information. After the telemedical application is started up, steps illustrated in FIG. 6 are carried out.

With reference to FIG. 6, the following describes steps to be carried out after the telemedical application is started up, (i) steps S311 to S316 which indicate steps to be carried out on the patient-side terminal 1 and (ii) steps S301 and S306 which indicate steps to be carried out on the server 3.

In order to obtain data to be displayed on the display 8, the communication section 11 of the patient-side terminal 1 transmits a data request to the server 3 (S311).

The communication section 31 of the server 3 receives the data request from the patient-side terminal 1 (S301). Then, the control section 33 of the server 3 connects to a database in the storage section 34 so as to extract requested data from the database (S302). Then, the communication section 31 transmits the extracted data to the patient terminal 1 (S303).

Then, the communication section 11 of the patient-side terminal 1 receives the data transmitted in response to the data request from the server 3, and outputs the received data to the display section 15 (S312). The display section 15 outputs the data received by the communication section 11 to the display 8 so that the data has a format that the display 8 can display (S313). On the basis of the output data, the display 8 displays information for the patient such as the biological information (measurement result), a history graph, an analysis result of the biological information, advice from an expert, etc. This allows the patient to view an image displayed on the display 8 while receiving a telemedical service.

The patient-side terminal 1 regularly checks, with the server 3, whether or not there is new data, even after the patient-side terminal 1 outputs display data to the display 8. Therefore, the patient-side terminal 1 transmits a data request to the server 3 in order to obtain new data (S314). Then, the communication section 11 of the patient-side terminal 1 receives the new data from the server 3 (Yes in S315), and outputs the new data to the display section 15. Then, the display section 15 outputs the new data to the display 8 so that the new data has a format that the display 8 can display (S313). In a case where the server 3 has no new data (No in S315), the patient-side terminal 1 checks, with the user, whether to end the process (S316). If No in S316, the communication section 11 transmits a data request to the server 3 again (S314). If Yes in S316, the patient-side terminal 1 ends the obtainment of data from the server 3.

With reference to FIG. 7, the following deals with a process to be carried out on the expert-side display apparatus 4 and a process to be carried out between the expert-side display apparatus 4 and the server 3. An expert first starts up a telemedical application on the expert-side display apparatus 4. Then, steps illustrated in FIG. 7 are carried out.

With reference to FIG. 7, the following describes steps to be carried out after the telemedical application is started up, (i) steps S321 to S326 which indicate steps to be carried out on the expert-side display apparatus 4 and (ii) steps S341 to S346 which indicate steps to be carried out on the server 3.

After the telemedical application is started up on the expert-side display apparatus 4, the expert-side display apparatus 4 causes the display 10 to display a patient list. The expert selects, from the patient list, a patient to be diagnosed and/or treated by the expert. The communication section 41 of the expert-side display apparatus 4 transmits, to the server 3, a data request for data of the patient thus selected (S321).

The communication section 31 of the server 3 receives the data request from the expert-side display apparatus 4 (S341). Then, the control section 33 of the server 3 connects to a database in the storage section 34 so as to extract requested data from the database (S342). Then, the communication section 31 transmits the extracted data to the expert-side display apparatus 4 (S343).

The communication section 41 of the expert-side display apparatus 4 receives, from the server 3, electronic medical record information provided from a medical institution, and also information such as the biological information of the patient and environmental information of a home of the patient (S322). The electronic medical record information provided from a medical institution can be one transmitted from the expert-side display apparatus 4. Alternatively, the electronic medical record information provided from a medical institution can be one transmitted from a medical information storage server in a medical institution which stores electronic medical records etc. and from an expert-side display apparatus which is different from the expert-side display apparatus 4. The display section 45 outputs the received data to the display 10 so that the received data has a format that the display 10 can display (S323). In this process, the display section 45 refers to parameters added to the pieces of first and second biological information so as to determine whether each of the pieces of first and second biological information is second biological information which was inputted by the user or first biological information which was directly obtained from the sensing apparatus 2. On the basis of a determination thus obtained, the display section 45 outputs the received data to the display 10 so that the first biological information and the second biological information in the received data can be distinguished from each other. In accordance with the requested data, the display 10 displays information for the expert such as the first and second biological information which was measured by the patient, a history graph, information displayed on the display 8 for the patient, and the electronic medical record. The first and second biological information and the history graph are displayed so that the expert can distinguish whether a piece of information is the first biological information which was directly obtained from the sensing apparatus 2 or the second biological information which was inputted by the user. This allows the expert to view the information displayed on the display 10 while providing a telemedical service to the patient. “Display so that the expert can distinguish . . . ” indicates that as described above for example, a color is varied in the display screen image 50 and a mark is varied on the display screen image 50, depending on whether a piece of information is first or second biological information.

The expert-side display apparatus 4 regularly checks, with the server 3, whether or not there is new data, even after the expert-side display apparatus 4 outputs display data to the display 10. Therefore, the experts-side display apparatus 4 transmits a data request to the server 3 so as to obtain the new data (S324). Then, the communication section 41 receives the new data from the server 3 (Yes in S325), and outputs the new data to the display section 45. Then, the display section 45 outputs the new data to the display 10 so that the new data has a format that the display 10 can display (S323). In a case where the server 3 does not have any new data (No in S325), the expert-side display apparatus 4 checks, with the user, whether to end the process (S326). If No in S326, the communication section 41 transmits a data request to the server 3 again (S324).

The patient-side terminal 1 and the expert-side display apparatus 4 in the telemedical system 100 repeatedly carry out the aforementioned steps until the telemedical service is completed (Yes in S316, Yes in S326).

<Process of Storing Medical Care Result in Server and Process of Notifying Patient-Side Terminal of the Medical Care Result>

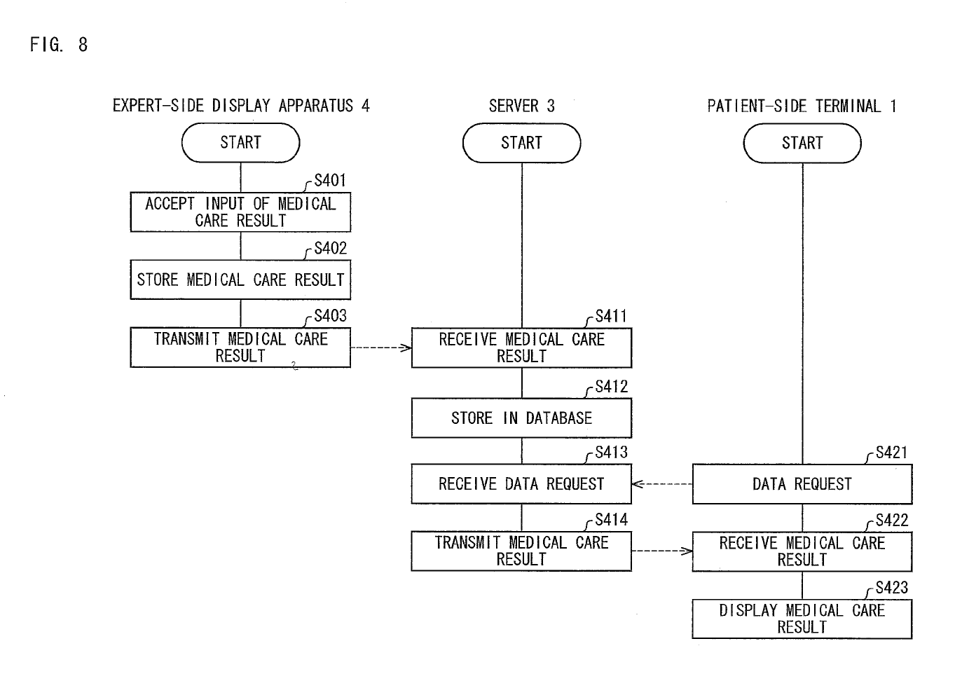

With reference to FIG. 8, the following describes a process of storing, in the server 3, a result of medical care conducted by an expert, and a process of notifying the patient-side terminal 1 of the result. FIG. 8 is a sequence diagram illustrating respective processing flows of the patient-side terminal 1, the server 3, and the expert-side display apparatus 4 which processing flows are carried out in notification of a medical care result to a patient in the telemedical service of the telemedical system 100.

With reference to FIG. 8, the following describes (i) steps S421 to S423 which indicate steps to be carried out on the patient-side terminal 1, (ii) steps S411 to S414 which indicate steps to be carried out on the server 3, and (iii) steps S401 to S403 which indicate steps to be carried out on the expert-side display apparatus 4.

An expert first utilizes the telemedical application on the expert-side display apparatus 4 in order to provide medical care to a target patient. The expert operates the operating device 9 connected with the expert-side display apparatus 4 in order to input a medical care result. The input section 42 of the expert-side display apparatus 4 accepts the medical care result from the expert (S401). The control section 43 causes the storage section 44 to store the medical care result accepted by the input section 42 (S402). Then, the communication section 41 transmits, to the server 3, the medical care result stored in the storage section 44 (S403).

The communication section 31 of the server 3 receives the medical care result data from the expert-side display apparatus 4 (S411). The control section 33 causes the storage section 34 to store, in a database in the storage section 34, the medical care result data thus received (S412). The communication section 31 of the server 3 receives a data request from the patient-side terminal 1 (S413). Then, in accordance with the data request, the server 3 extracts requested medical care result from the database so as to transmit the extracted medical care result data to the patient-side terminal 1 via the communication section 31 (S414).

In order to obtain the medical care record, the communication section 11 of the patient-side terminal 1 transmits the data request to the server 3 (S421). Then, the communication section 11 receives the medical care result data which was transmitted from the server 3 in accordance with the data request, and outputs the medical care result to the display section 15 (S422). The display section 15 outputs the medical care result to the display 8 so that the medical care result has a format that the display 8 can display. The display section 15 thus causes the display 8 to display the medical care result (S423).

Thus, a user (patient) can view, in his home, a result of medical care which is provided by an expert on the basis of first and second biological information obtained in the home of the user. In the medical care, further, the expert can take into account reliability of the first and second biological information. As a result, the result of the medical care can be more reliable.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The biological information processing apparatus of the present invention is preferably arranged such that: the information obtaining means further obtains measurement apparatus information related to the measurement apparatus; and the transmitting means transmits the measurement apparatus information obtained by the information obtaining means to the server.

According the arrangement, the biological information processing apparatus can automatically obtain information on the measurement apparatus which has measured the first biological information. This allows an expert such as a doctor to determine a body condition of a patient on the basis of the first and second biological information of the patient, in consideration of what the measurement apparatus is. As a result, the expert can determine the body condition more accurately.

“Display the first and second biological information so that whether each of the first biological information and the second biological information is information obtained by the measurement apparatus or information inputted by the user can be distinguished” may refer to “the display means displays the biological information differently depending on whether the biological information is information obtained by the measurement apparatus or information inputted by the user.”

According to the arrangement, a method by which the display means displays the biological information is varied depending on whether the biological information is information obtained by the measurement apparatus or information inputted by the user. This allows an expert such as a doctor to easily determine whether the biological information is information obtained by the measurement apparatus or information inputted by the user.

“A method for displaying biological information is varied” may refer to “a display color for the biological information on the display screen is varied depending on whether the biological information is information obtained by the measurement apparatus or information inputted by the user.” Alternatively, “a method for displaying biological information is varied” may refer to “a mark which indicates the biological information on the display screen is varied depending on whether the biological information is information obtained by the measurement apparatus or information inputted by the user.”

Further, the biological information display apparatus of the present invention is preferably arranged such that: the receiving means further obtains measurement apparatus information related to the measurement apparatus; and the display means causes the measurement apparatus information to be displayed on the display screen.

This allows an expert such as a doctor to determine a body condition of a patient on the basis of the first and second biological information of the patient, in consideration of what the measurement apparatus is. As a result, the expert can determine the body condition more accurately.

Further, the biological information display apparatus of the present invention is preferably arranged such that: the receiving means further receives medical information of the user; and the display means causes the medical information to be displayed on the display screen.

According to the arrangement, an expert such as a doctor can view the biological information and the medical information of a user together. This allows the expert to diagnose and treat the user more easily.

Further, the biological information display apparatus of the present invention is preferably arranged such that the display means causes a plurality of types of information to be displayed on the display screen in a combined manner.

According to the arrangement, an expert such as a doctor can view a plurality of types of information at once. This allows the expert to determine a body condition of a patient more easily.

The telemedical system of the present invention may include a plurality of measurement apparatuses.

Since it is possible to obtain a plurality of types of biological information according to the arrangement, an expert such as a doctor can utilize the plurality of types of biological information so as to determine a body condition a patient. This allows the expert to determine the body condition more accurately.

Further, the telemedical system of the present invention may include a plurality of biological information processing apparatuses.

According to the arrangement, an expert such as a doctor can provide a telemedical service to many patients by use of the telemedical system.

Finally, the blocks of each of the patient-side terminal 1 and the expert-side display apparatus 4 can be realized by way of hardware or software as executed by a CPU (Central Processing Unit) as follows.

The patient-side terminal 1 includes a CPU and memory devices (memory media). The CPU executes instructions in control programs realizing functions. The memory devices include a ROM (Read Only Memory) which contains the control programs, a RAM (Random Access Memory) to which the control programs are loaded so as to have an executable format, and a memory containing the control programs and various data.

The arrangement makes it possible to achieve the object of the present invention by use of a predetermined storage medium. The storage medium stores, in a computer-readable manner, that control program code (executable program, intermediate code program, or source program) for the patient-side terminal 1 or the expert-side display apparatus 4 which is software realizing the aforementioned functions. The storage medium is mounted to the patient-side terminal 1 or the expert-side display apparatus 4. This allows the patient-side terminal 1 or the expert-side display apparatus 4 (or CPU, MPU), which serves as a computer, to read out the control program code from the storage medium so as to execute the control program.

The storage medium which supplies the control program code to the patient-side terminal 1 or to the expert-side display apparatus 4 is not particularly limited in its structure and type. The storage medium can be, for example, a tape such as a magnetic tape or a cassette tape, a magnetic disk such as a floppy® disk or a hard disk, or an optical disk such as CD-ROM/MO/MD/DVD/CD-R, a card such as an IC card (including a memory card) or an optical card, or a semiconductor memory such as a mask ROM/EPROM/EEPROM/flash ROM.

The object of the present invention can be achieved by arranging such that the patient-side terminal 1 or the expert-side display apparatus 4 is connectable to a communications network. In this case, the control program code is supplied to the patient-side terminal 1 or the expert-side display apparatus 4 via the communication network. The communication network is not particularly limited in its type and form, provided that the communication network makes it possible to supply the control program code to the patient-side terminal 1 or the expert-side display apparatus 4. For example, the communication network can be the Internet, an intranet, extranet, LAN, ISDN, VAN, CATV communications network, virtual dedicated network (virtual private network), telephone line network, mobile communications network, or satellite communications network.

A transfer medium which makes up the communications network is also not particularly limited in its arrangement and type but can be any medium which can transfer the control program code. The transfer medium can be, e.g., wired line such as IEEE 1394, USB (Universal Serial Bus), electric power line, cable TV line, telephone line, or ADSL (Asymmetric Digital Subscriber Line) line, or wireless such as infrared radiation (IrDA, remote control), Bluetooth®, 802.11 wireless, HDR, mobile telephone network, satellite line, or terrestrial digital network. The present invention encompasses a carrier wave or data signal transmission in which the program code is embodied electronically. The present invention can be also realized by the program code in the form of a computer data signal embedded in a carrier wave which is embodied by electronic transmission.

### INDUSTRIAL APPLICABILITY

The present invention is widely applicable to a telemedical system which provides, to a patient and an expert, a telemedical application to be used between a personal space such as a home and a medical institute such as a hospital.

### REFERENCE SIGNS LIST

1 Patient-side terminal (biological information processing apparatus)

2 Sensing apparatus (measurement apparatus)

3 Server

4 Expert-side display apparatus (biological information display apparatus)

11 Communication section (information obtaining means, transmitting means)

12 Input section (input accepting means)

13 Control section (processing means)

14, 22, 34, 44 Storage section

21, 31 Communication section

23 Measuring section

32 Analysis section

33 Control section

41 Communication section (receiving means)

42 Input section

43 Control section (determining means)

45 Display section (display means)

100 Telemedical system

1. A biological information processing apparatus comprising:
information obtaining means for obtaining first biological information indicative of a physiological state of a user from a measurement apparatus which measures the first biological information;
input accepting means for accepting an input from the user so as to obtain second biological information indicative of a physiological state of the user;
processing means for (i) adding, to the first biological information, first distinguishing information indicating that the first biological information is information obtained by the information obtaining means, and (ii) adding, to the second biological information, second distinguishing information indicating that the second biological information is information obtained by the input accepting means, so that the first biological information and the second biological information are distinguished from each other; and
transmitting means for transmitting, to the server, at least any one of the first biological information having the first distinguishing information and the second biological information having the second distinguishing information,
the biological information processing apparatus being connected with the server via a communication network.

2. The biological information processing apparatus as set forth in claim 1, wherein:
the information obtaining means further obtains measurement apparatus information related to the measurement apparatus; and
the transmitting means transmits the measurement apparatus information obtained by the information obtaining means to the server.

3. A biological information processing apparatus comprising:
any one of information obtaining means and input accepting means,
the information obtaining means for obtaining first biological information indicative of a physiological state of a user from a measurement apparatus which measures the first biological information,
the input accepting means for accepting an input from the user so as to obtain second biological information indicative of a physiological state of the user; and
processing means for (i) adding, to the first biological information, first distinguishing information indicating that the first biological information is information obtained by the information obtaining means, or (ii) adding, to the second biological information, second distinguishing information indicating that the second biological information is information obtained by the input accepting means, so that the first biological information and the second biological information are distinguished from each other; and
transmitting means for transmitting, to the server, the first biological information having the first distinguishing information or the second biological information having the second distinguishing information,
the biological information processing apparatus being connected with the server via a communication network.

4. A biological information display apparatus comprising:
receiving means for receiving, from a biological information processing apparatus, at least any one of first biological information and second biological information each of which indicates a physiological state of a user, the first biological information and the second biological information each obtained by the biological information processing apparatus;
determining means for determining whether the at least any one of the first biological information and the second biological information which at least any one of the first biological information and the second biological information was received by the receiving means is information obtained by a measurement apparatus which measures first biological information or information inputted by the user; and
display means for causing, on the basis of a determination thus made by the determining means, the at least any one of the first biological information and the second biological information to be displayed on a display screen so that whether the at least any one of the first biological information and the second biological information is information obtained by the measurement apparatus or information inputted by the user can be distinguished.

5. The biological information display apparatus as set forth in claim 4, wherein the display means displays the biological information differently depending on whether the biological information is information obtained by the measurement apparatus or information inputted by the user.

6. The biological information display apparatus as set forth in claim 5, wherein a display color for the biological information on the display screen is varied depending on whether the biological information is information obtained by the measurement apparatus or information inputted by the user.

7. The biological information display apparatus as set forth in claim 5, wherein a mark which indicates the biological information on the display screen is varied depending on whether the biological information is information obtained by the measurement apparatus or information inputted by the user.

8. The biological information display apparatus as set forth in claim 4, wherein:
the receiving means further obtains measurement apparatus information related to the measurement apparatus; and
the display means causes the measurement apparatus information to be displayed on the display screen.

9. The biological information display apparatus as set forth in claim 4, wherein:
the receiving means further receives medical information of the user; and
the display means causes the medical information to be displayed on the display screen.

10. The biological information display apparatus as set forth in claim 4, wherein the display means causes a plurality of types of information to be displayed on the display screen in a combined manner.

11. A telemedical system comprising:
a measurement apparatus which measures first biological information indicative of a physiological state of a user;
a biological information processing apparatus;
a biological information display apparatus; and
a server which communicates, via a network, with the biological information processing apparatus and with the biological information display apparatus,
the biological information processing apparatus including:
information obtaining means for obtaining first biological information indicative of a physiological state of a user from the measurement apparatus;
input accepting means for accepting an input from the user so as to obtain second biological information indicative of a physiological state of the user;
processing means for (i) adding, to the first biological information, first distinguishing information indicating that the first biological information is information obtained by the information obtaining means, and (ii) adding, to the second biological information, second distinguishing information indicating that the second biological information is information obtained by the input accepting means, so that the first biological information and the second biological information are distinguished from each other; and
transmitting means for transmitting, to the server, at least any one of the first biological information having the first distinguishing information and the second biological information having the second distinguishing information,
the biological information display apparatus including:
receiving means for receiving at least any one of the first biological information and the second biological information from the server;
determining means for determining whether the at least any one of the first biological information and the second biological information is information obtained by the measurement apparatus or information obtained in such a manner that the biological information processing apparatus accepts an input from the user; and
display means for causing, on the basis of a determination thus made by the determining means, the at least any one of the first biological information and the second biological information to be displayed on a display screen so that whether the at least any one of the first biological information and the second biological information is information obtained by the measurement apparatus or information inputted by the user can be distinguished.

12. The telemedical system as set forth in claim 11, comprising a plurality of measurement apparatuses.

13. The telemedical system as set forth in claim 12, comprising a plurality of biological information processing apparatuses.

14. A telemedical method comprising:
an information obtaining step in which a biological information processing apparatus which obtains first biological information and second biological information each of which indicates a physiological state of a user obtains first biological information from a measurement apparatus which measures first biological information;
an input accepting step in which the biological information processing apparatus accepts an input from the user so as to obtain second biological information;
a processing step in which the biological information processing apparatus (i) adds, to the first biological information obtained in the information obtaining step, first distinguishing information indicating that the first biological information is information obtained in the information obtaining step, and (ii) adds, to the second biological information obtained in the input accepting step, second distinguishing information indicating that the second biological information is information obtained in the input accepting step, so that the first biological information and the second biological information are distinguished from each other;
a transmitting step in which the biological information processing apparatus transmits, to a server, the first biological information having the first distinguishing information and the second biological information having the second distinguishing information;
a receiving step in which a biological information display apparatus which displays first biological information and second biological information receives the first biological information and the second biological information from the server;
a determining step in which the biological information display apparatus determines whether each of the first biological information and the second biological information is information that the biological information processing apparatus obtained from the measurement apparatus or information obtained in such a manner that the biological information processing apparatus accepted the input form the user; and
a displaying step in which the biological information display apparatus causes, on the basis of a determination thus made in the determining step, the first biological information and the second biological information to be displayed on a display screen so that whether each of the first biological information and the second biological information is information obtained by the measurement apparatus or information inputted by the user can be distinguished.

15. A processing control program which causes a biological information processing apparatus recited in claim 1 to operate, the processing control program causing a computer to serve as respective means.

16. A display control program which causes a biological information display apparatus recited in claim 4 to operate, the display control program causing a computer to serve as respective means.

17. A computer-readable storage medium storing a processing control program recited in claim 15.

18. A computer-readable storage medium storing a display control program recited in claim 16.

19. A processing control program which causes a biological information processing apparatus recited in claim 3 to operate, the processing control program causing a computer to serve as respective means.

20. A computer-readable storage medium storing a processing control program recited in claim 19.
